(19) United States
(12) Patent Application Publication
(10) Pub. No.: US 2012/0154763 A1
(43) Pub. Date: Jun. 21, 2012

(54) PROJECTION DISPLAY DEVICE

(75) Inventors: Shinya NODA, Osaka (JP); Akira MIYANAGA, Osaka (JP)

(73) Assignee: SANYO ELECTRIC CO., LTD., Osaka (JP)

(21) Appl. No.: 13/328,693

(22) Filed: Dec. 16, 2011

(30) Foreign Application Priority Data
Dec. 16, 2010 (JP) 2010-280646

(51) Int. Cl. G03B 21/16; G03B 21/20

(52) U.S. Cl. 353/58; 353/85

(57) ABSTRACT

A projection display device includes: a light source device which has a plurality of light source parts, and combines light from the light source parts and outputs the same; a light modulating part which modulates light output from the light source device; a main body cabinet in which the light source device and the light modulating part are disposed; a plurality of opening parts which are provided in the main body cabinet and through which the light source parts are individually put into or taken out; a plurality of covers which cover the corresponding opening parts; and a light source control part. When any of the covers is opened during operation, the light source control part controls the light source parts except for the light source part corresponding to the opened cover, in such a manner as to reduce intensity of light emitted from the other light source parts.

This application claims priority under 35 U.S.C. Section 119 of Japanese Patent Application No. 2010-280646 filed Dec. 16, 2010, entitled “PROJECTION DISPLAY DEVICE”. The disclosure of the above application is incorporated herein by reference.

### BACKGROUND OF THE INVENTION

1. Field of the Invention

The present invention relates to a projection display device that modulates light from a light source and projects the modulated light onto a projection plane.

2. Disclosure of Related Art

Conventionally, a projection display device such as a liquid crystal projector (hereinafter, referred to as “projector”) modulates light by an imager such as a liquid crystal panel, and projects the modulated light by a projection lens onto a projection plane. The light source uses a lamp, for example. The lamp becomes degraded when used for a long time. At the end of its life, the lamp needs to be replaced with a new one.

Such a projector as described above can be configured in a so-called multi-lamp system in which a plurality of lamps is provided for achieving high intensity. Even if one lamp does not illuminate due to the end of its life or failure, the multi-lamp projector can continue operation with the remaining lamps, although projected images are reduced in brightness. Accordingly, the multi-lamp projector can be configured to allow replacement of an off-state lamp while continuing operation.

The projector main body can be provided with lamp openings through which individual lamps are put into or taken out of the projector. In this arrangement, the lamp openings are covered with their respective covers. At replacement of a lamp, a user opens the cover and takes out the lamp.

As in the foregoing, if the projector continues operation at replacement of a lamp, when the user opens the cover corresponding to the lamp to be replaced, light from other lamps can be leaked and released through the lamp opening. In such a case, there is a fear that the user cannot replace the lamp smoothly due to glare of the released light.

### SUMMARY OF THE INVENTION

A projection display device according to a main aspect of the present invention, includes: a light source device which has a plurality of light source parts, and combines light from the light source parts and outputs the same; a light modulating part which modulates light output from the light source device; a main body cabinet in which the light source device and the light modulating part are disposed; a plurality of opening parts which are provided in the main body cabinet and through which the light source parts are individually put into or taken out; a plurality of covers which cover the corresponding opening parts; and a light source control part which controls the light source parts. In this arrangement, when any of the covers is opened during operation, the light source control part controls the light source parts except for the light source part corresponding to the opened cover, in such a manner as to reduce intensity of light emitted from the light source parts.

The projection display device can be provided with a detection part for detecting opening of the cover.

### BRIEF DESCRIPTION OF THE DRAWINGS

These and other objects, and novel features of the present invention will become more apparent upon reading the following detailed description of the embodiment along with the accompanying drawings.

FIG. 1 is a diagram showing an outer configuration of a projector in an embodiment of the present invention;

FIG. 2 is a diagram showing an inner structure of the projector in the embodiment;

FIG. 3 is a diagram showing a configuration of an optical system in the embodiment;

FIG. 4 is a diagram showing a configuration of a light source device in the embodiment;

FIG. 5 is a diagram showing a configuration of the light source device in the embodiment;

FIGS. 6A and 6B are diagrams showing a configuration of a lamp unit in the embodiment;

FIGS. 7A and 7B are diagrams showing a configuration for detecting opening/closing of a lamp cover in the embodiment;

FIG. 8 is a block diagram showing a configuration of a control system of the projector in the embodiment;

FIGS. 9A and 9B are diagrams for describing a lamp control process at lamp replacement during operation in the embodiment;

FIGS. 10A and 10B are diagrams for describing a projector in a modification example 1;

FIGS. 11A and 11B are diagrams for describing a projector in a modification example 2;

FIGS. 12A and 12B are diagrams for describing a projector in a modification example 3; and

FIGS. 13A and 13B are diagrams for describing a projector in a modification example 4.

However, the drawings are intended only for illustration, and do not limit the scope of the present invention.

### DESCRIPTION OF PREFERRED EMBODIMENTS

A projector in an embodiment of the present invention will be described below with reference to the drawings.

In this embodiment, lamp openings 3a are equivalent to “opening parts” recited in the claims; lamp covers 7 are equivalent to “covers” recited in the claims; liquid crystal panels 102, 103, and 104 are equivalent to an “light modulating part” recited in the claims; lamp units 300 are equivalent to “light source parts,” “first light source part,” “second light source part,” “third light source part,” and “fourth light source part” recited in the claims; and a control part 501 is equivalent to a “light source control part” and a “fan control part” recited in the claims. The foregoing correspondences in description between the claims and this embodiment are merely examples, and do not limit the claims to this embodiment.

### Entire Configuration of the Projector

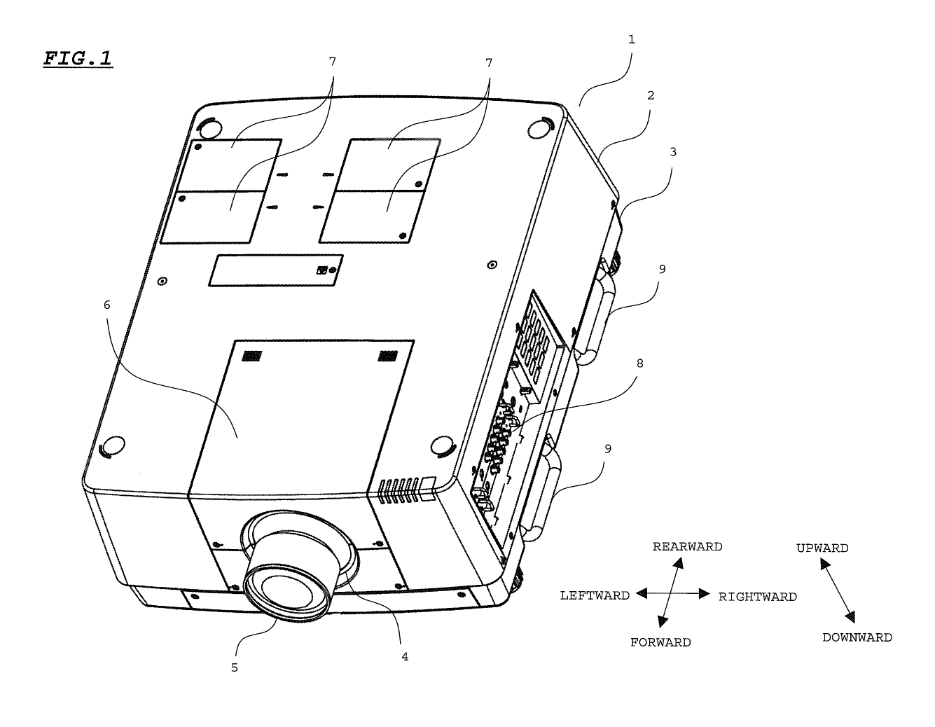

FIG. 1 is a diagram showing an outer configuration of the projector. The projector in this embodiment is a so-called, four-lamp type large-sized projector including four lamp units.

Referring to FIG. 1, the projector includes a main body cabinet 1 having the shape of an approximately rectangular parallelepiped. The main body cabinet 1 is configured to have a lower cabinet 2 and an upper cabinet 3 laid on the lower cabinet 2 from above.

The upper cabinet 3 has a projection window 4 at a center of a front surface thereof, and a front surface of the projection lens 5 is exposed outward through the projection window 4.

In addition, the upper cabinet 3 has a main cover 6 covering a main opening from the front to upper surfaces thereof. The main opening is provided for replacement of the projection lens 5 and a prism unit, and for adjustment of a polarizer and the like. The upper cabinet 3 has four lamp covers 7 covering four lamp openings at a rear portion of the upper surface thereof. The lamp openings are provided for replacement of the lamp units.

Further, the upper cabinet 3 has an input/output terminal part 8 on a right side surface thereof. The input/output terminal part 8 has various AV terminals through which audio visual (AV) signals are input.

The lower cabinet 2 has two each handles 9 on right and left side surfaces thereof. The handles 9 are used for carrying the projector.

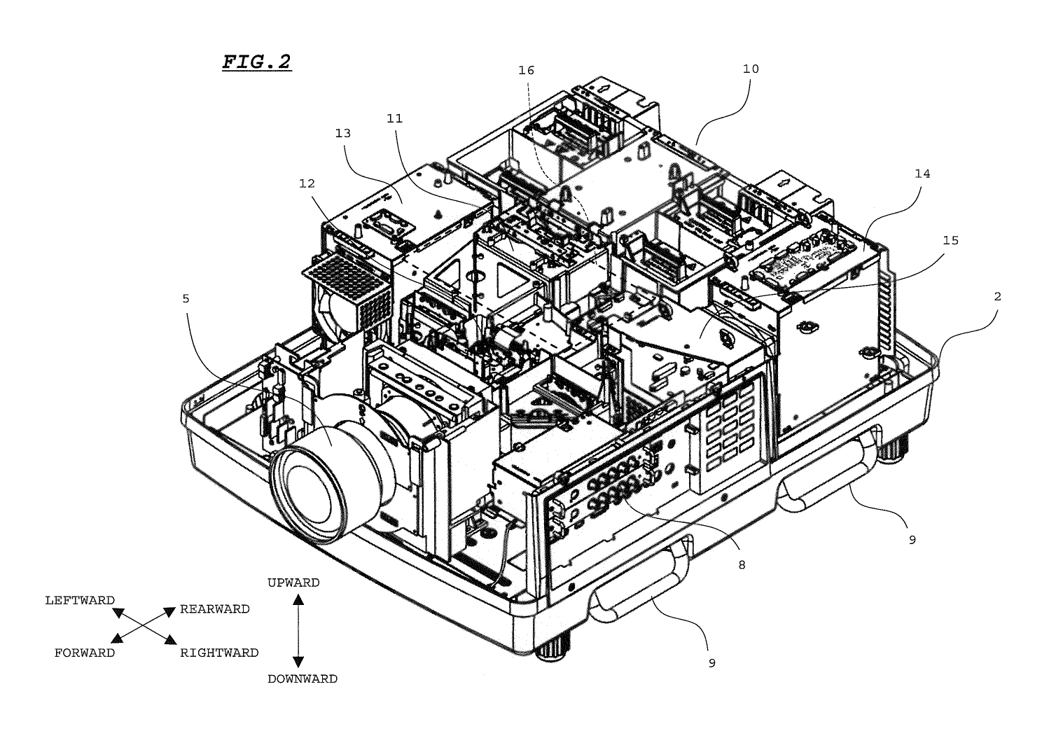

FIG. 2 is a diagram showing an inner structure of the projector with the upper cabinet 3 removed.

Referring to FIG. 2, the lower cabinet 2 contains alight source device 10, and an optical system 11 which modulates light emitted from the light source device 10 and generates image light.

The light source device 10 is disposed at a rear portion of the lower cabinet 2. The optical system 11 is disposed in front of the light source device 10. The optical system 11 has a prism unit 12 in such a manner as to be capable of being attached or detached from above. Detailed configurations of the light source device 10 and the optical system 11 will be described later.

The projection lens 5 is disposed in front of the optical system 11. The projection lens 5 enlarges image light generated by the optical system 11 and projects the same onto a projection plane such as a screen or the like.

A first lamp power source unit 13 is disposed on a left side of the optical system 11, and a second lamp power source unit 14 is disposed on a right side of the light source device 10. The first lamp power source unit 13 includes two lamp power source parts which supply electric power to the two front and rear lamp units on the left side of the light source device 10. The second lamp power source unit 14 includes two lamp power source parts which supply electric power to the two front and rear lamp units on the right side of the light source device 10. In addition, a main power source unit 15 is disposed in front of the second lamp power source unit 14. The main power source unit 15 supplies electric power to electric components (liquid crystal panels and the like) constituting the optical system 11, a control board 16, and the like.

The control board 16 is disposed above the optical system 11. The control board 16 includes a control circuit for controlling electric components such as the liquid crystal panels, the lamp units, and the like. In FIG. 2, the control board 16 is shown by broken lines to make the optical system 11 see-through.

### Configuration of the Optical System

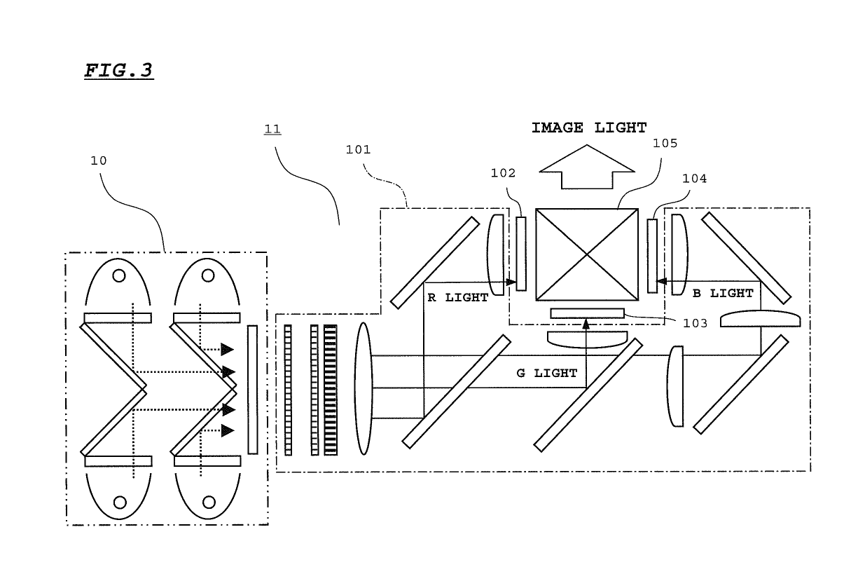

FIG. 3 is a diagram showing a configuration of the optical system 11.

As shown in FIG. 3, the optical system 11 includes a light-guiding optical system 101, three transmissive liquid crystal panels 102, 103, and 104, and a dichroic prism 105. The liquid crystal panels 102, 103, and 104 have polarizers not shown at incident and output sides.

White light emitted from the light source device 10 enters the light-guiding optical system 101. The light-guiding optical system 101 includes a fly-eye integrator, a PBS array, a condenser lens, a dichroic mirror, a plane mirror, a relay lens, and the like. The white light having entered the light-guiding optical system 101 is separated into a light of a red wavelength band (hereinafter, referred to as “R light”), a light of a green wavelength band (hereinafter, referred to as “G light”), and a light of a blue wavelength band (hereinafter, referred to as “B light”), and the separated lights are irradiated to the liquid crystal panels 102, 103, and 104. The R, G, and B lights modulated by the liquid crystal panels 102, 103, and 104 are combined by the dichroic prism 105, and are emitted as image light. The liquid crystal panels 102, 103, and 104 and the dichroic prism 105 are integrated to constitute the prism unit 12.

Instead of the transmissive liquid crystal panels 102, 103, and 104, imagers forming the optical system 11 may use reflective liquid crystal panels or MEMS devices. In addition, the optical system 11 may not be a three-plate optical system including three imagers as described above, but may be a single-plate optical system using one imager and a color wheel, for example.

### Configuration of the Light Source Device

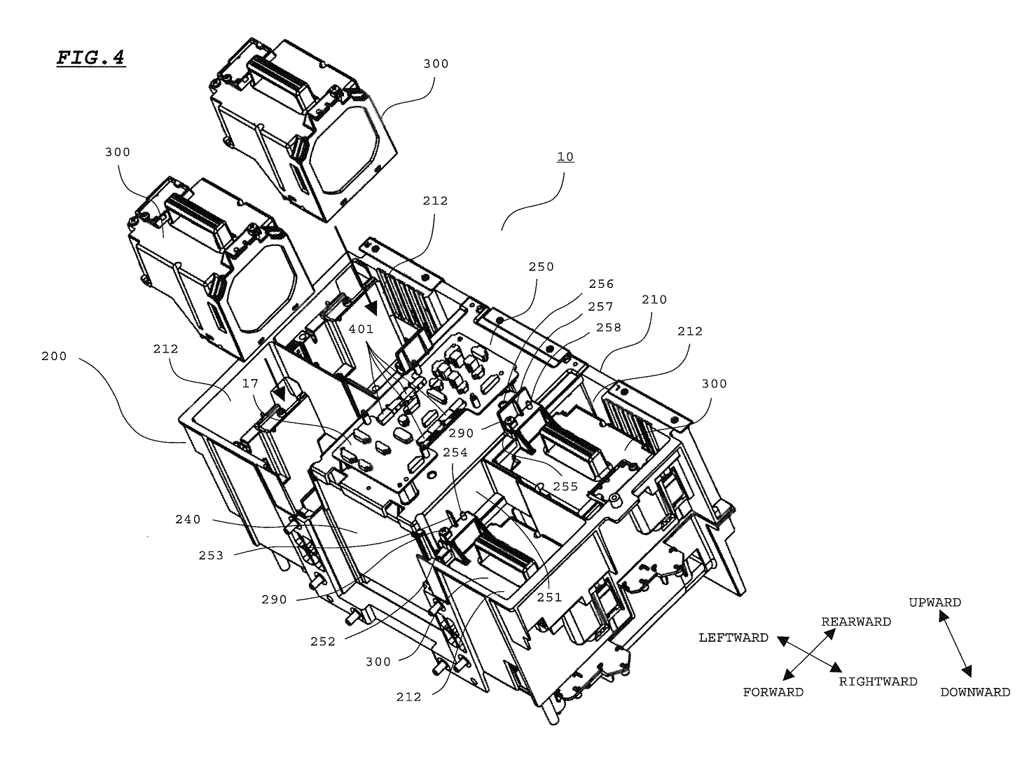

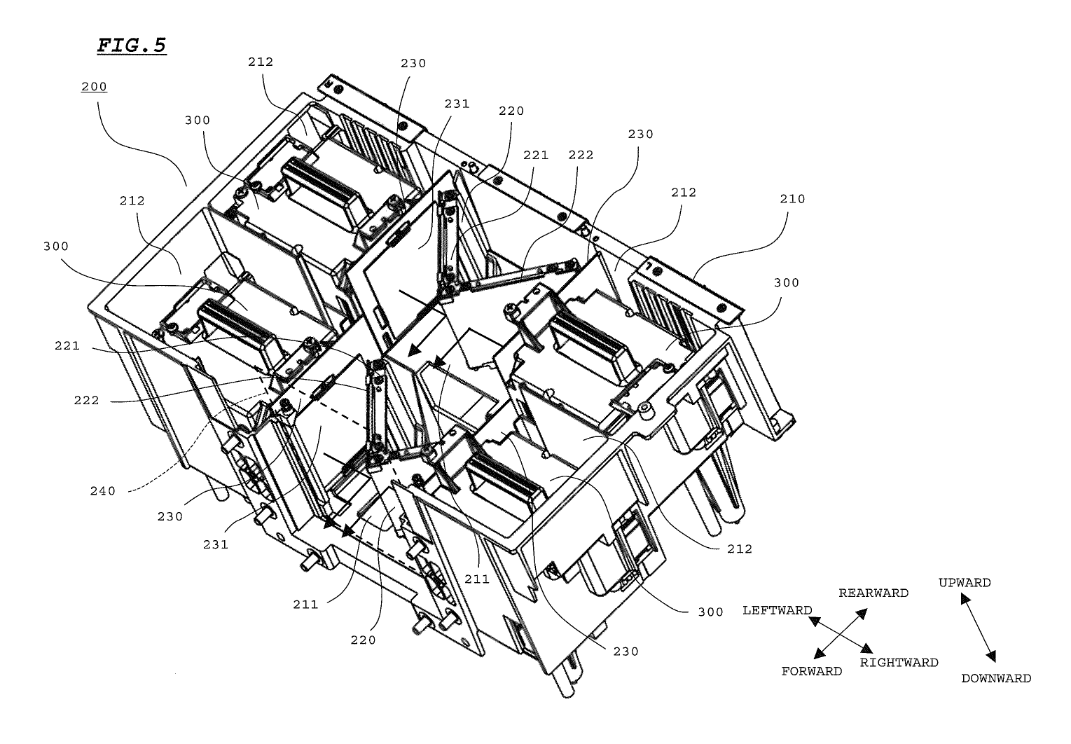

FIGS. 4 and 5 are diagrams showing a configuration of the light source device 10. FIG. 4 is a perpendicular view of a lamp attachment unit 200 from which two lamp units 300 are removed. FIG. 5 is a perpendicular view of the lamp attachment unit 200 from which a mirror cover 250 is removed.

Referring to FIGS. 4 and 5, the light source device 10 is formed by the lamp attachment unit 200 fixed to the lower cabinet 2, and four lamp units 300 attached to the lamp attachment unit 200.

The lamp attachment unit 200 includes a housing 210, two mirror members 220, four first UV-cutoff members 230, a second UV-cutoff member 240, and a mirror cover 250.

The housing 210 is made of a resin material, and has two mirror placement parts 211 disposed at a center thereof and four lamp storage parts 212 formed on both sides of the mirror placement parts 211. The front-side mirror placement part 211 has a bottom surface lower than a bottom surface of the rear-side mirror placement part 211. In addition, the two front-side right and left lamp storage parts 212 have bottom surfaces lower than bottom surfaces of the two rear-side right and left lamp storage parts 212. The mirror members 220 are placed at the mirror placement parts 211. The lamp units 300 are attached in the lamp storage parts 212.

The mirror members 220 include V-shaped base members 221, and V-shaped plane mirrors 222 attached to front surfaces of the base members 221. The mirror members 220 reflect light emitted from the lamp units 300 and guide the same forward.

The first UV-cutoff members 230 include UV-cutoff glasses 231 for blocking passage of ultraviolet rays. The first UV-cutoff members 230 are positioned between the lamp storage parts 212 and the corresponding mirror placement parts 211.

The second UV-cutoff members 240 are UV-cutoff glasses for blocking passage of ultraviolet rays, which are disposed in front of the front mirror placement parts 211. The second UV-cutoff members 240 are set higher than a path of the light reflected by the rear mirror member 220 and traveling forward.

The mirror cover 250 covers upper sides of the mirror placement parts 211. The mirror cover 250 has side parts 251 on right and left of a front side thereof, which extend down to upper ends of the first UV-cutoff members 230. The side parts 251 have receiving portions 252. When the lamp units 300 are attached in the lamp storage parts 212, the receiving portions 252 receive flange portions 326a of the lamp units 300. The receiving portions 252 have guide ribs 253 extending upward therefrom and positioning pins 254 projecting therefrom. The mirror cover 250 also has receiving portions 255 on right and left of a rear side thereof. The receiving portions 255 have guide plates 256 extending upward therefrom and guide ribs 257 formed on the guide plates 256. The receiving portions 255 also have positioning pins 258.

A sub board 17 is placed on an upper surface of the mirror cover 250. The sub board 17 is provided with detection switches 401 for detecting opening/closing of the lamp covers 7. The detection switches 401 use micro-switches, for example. The detection switches 401 are disposed in correspondence with the lamp covers 7.

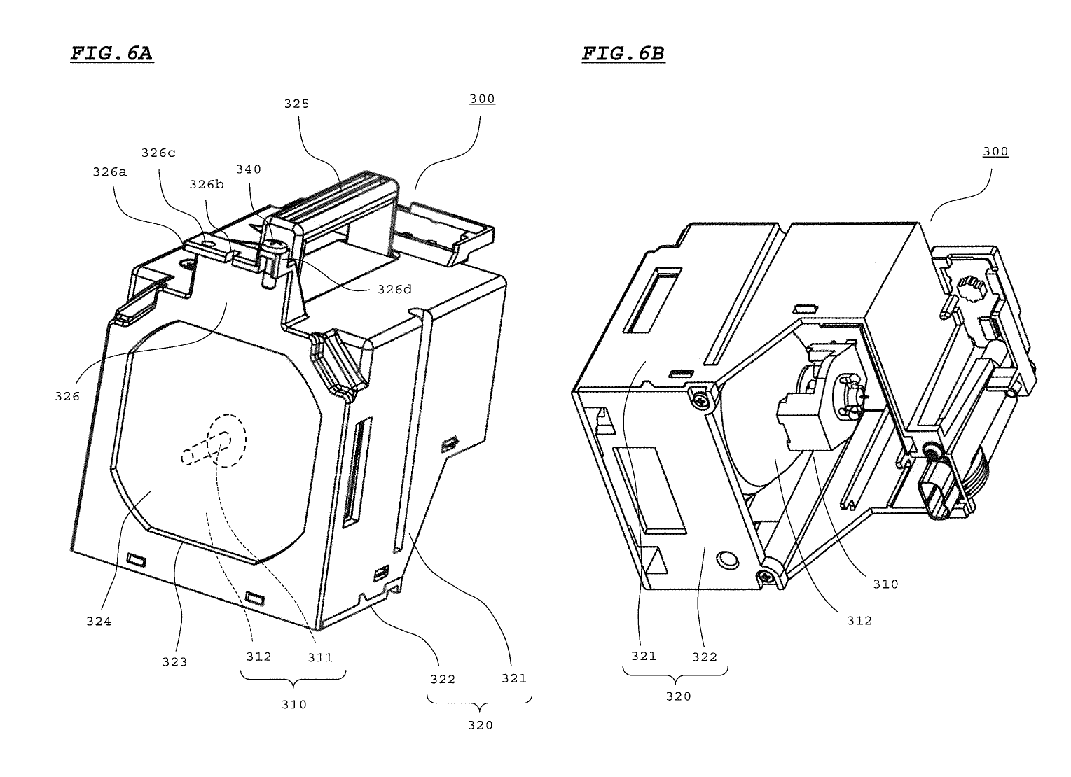

FIGS. 6A and 6B are diagrams showing a configuration of the lamp unit 300. FIG. 6A is a perpendicular view of the lamp unit 300 seen from a front oblique direction. FIG. 6B is a perpendicular view of the lamp unit 300 seen from a rear oblique direction.

Referring to FIGS. 6A and 6B, the lamp unit 300 is configured to have a lamp 310 and a lamp holder 320 holding the lamp 310. The lamp 310 includes a luminous tube 311 emitting white light and a reflector 312 reflecting white light emitted from the luminous tube 311. The lamp 310 uses an ultrahigh pressure mercury lamp, a xenon lamp, or the like, for example.

The lamp holder 320 is made of a resin material, and includes a holder main body 321 and a bottom plate 322. The holder main body 321 has on a front surface thereof an output window 323 through which light from the lamp 310 is emitted. A heat-resistance glass plate 324 is fitted into the output window 323. The holder main body 321 has an open bottom surface through which the lamp 310 is attached from underneath. The bottom plate 322 is attached to a front half of the bottom surface of the holder main body 321, thereby supporting the lamp 310 at a bottom thereof.

The holder main body 321 has a handle 325 on a top surface thereof. The handle 325 is used to carry the lamp unit 300 and attach or detach the lamp unit 300 to or from the lamp attachment unit 200. The holder main body 321 has a lamp fixing part 326 in front of the handle 325. The lamp fixing part 326 includes a flange portion 326a formed at an upper end thereof. The flange portion 326a has a guide groove 326b, a positioning hole 326c, and a screw hole portion 326d. A screw 340 is inserted into the screw hole portion 326d.

As shown in FIG. 4, the lamp units 300 are inserted into the lamp storage parts 212, such that front sides (output window 323 sides) of the lamp units 300 face the mirror placement parts 211. At that time, the guide grooves 326b of the flange portions 326a are aligned with the guide ribs 253 (257) of the mirror cover 250.

When the lamp units 300 are fully attached to the lamp storage parts 212, the flange portions 326a of the lamp units 300 contact the receiving portions 252 (255) of the mirror cover 250, and the positioning pins 254 (258) are fitted into the positioning holes 326c of the flange portions 326a. The flange portions 326a are fixed to the receiving parts 252 (255) by the screws 340 inserted into the screw hole portions 326d (see FIG. 4). Accordingly, the lamp units 300 are fixed to the lamp attachment units 200.

When the projector is started in a state where the four lamp units 300 are assembled into the lamp attachment units 200, the lamp units 300 emit light. As shown in FIG. 5, the light emitted from the lamp units 300 pass through the corresponding first UV-cutoff members 230 while being cleared of ultraviolet rays. Then, the light having passed through the first UV-cutoff members 230 is reflected by the mirror members 220 corresponding to the lamp units 300 and is combined into one light, and then the combined light travels forward. In this arrangement, the two front lamp units 300 are positioned lower than the two rear lamp units 300. Therefore, the light from the rear lamp units 300 is not blocked by the front lamp units 300. The combined light then passes through the second UV-cutoff members 240 while being further cleared of ultraviolet rays. As in the foregoing, since the light from the four lamp units 300 is combined, the light source device 10 emits high-intensity light.

### Configuration for Detecting Opening/Closing of the Lamp Covers

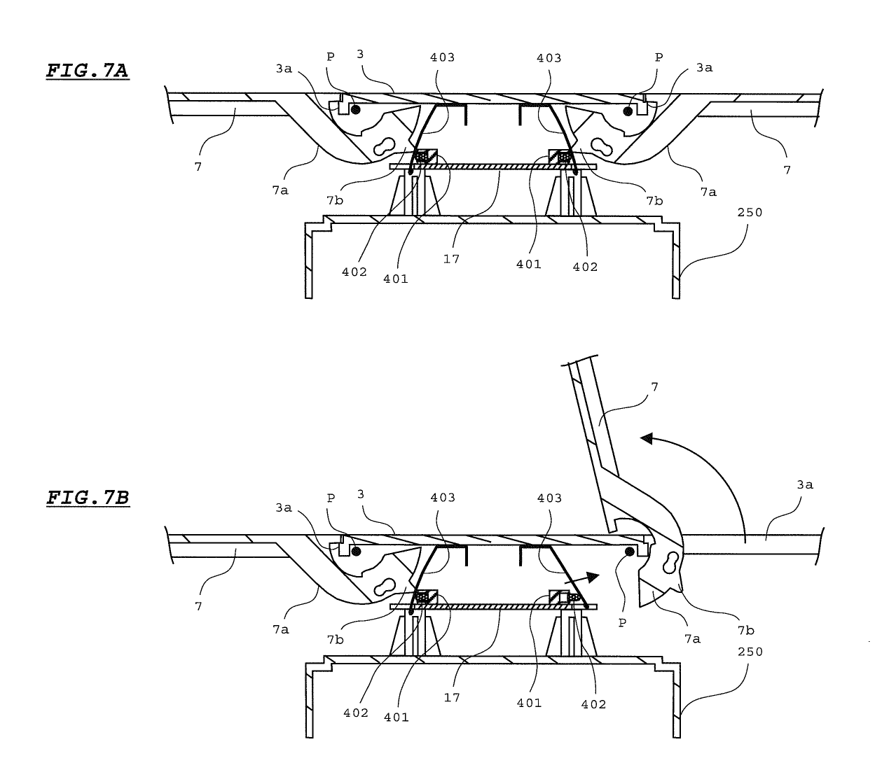

FIGS. 7A and 7B are diagrams showing a configuration for detecting opening/closing of the lamp covers 7, which are cross-sectional views of main components in which the upper cabinet 3 is cut with a surface perpendicular to the forward-rearward direction at the lamp covers 7. FIG. 7A shows that the two right and left lamp covers 7 are closed, and FIG. 7B shows that one of the two lamp covers 7 is opened. Out of the four front and rear lamp covers 7, FIGS. 7A and 7B show the two front- or rear-side right and left lamp covers 7. The other two front- or rear-side right and left lamp covers 7 are structured in the same manner as the illustrated lamp covers 7.

Referring to FIGS. 7A and 7B, rotation axes P of the right and left lamp covers 7 are set in a front-rear direction along edge portions of the lamp openings 3a on the mirror placement part 211 sides. The lamp covers 7 rotate around the rotation axes P and open or close the lamp openings 3a.

The lamp covers 7 have levers 7a at end portions thereof on the rotation axis P sides. The levers 7a have projecting portions 7b. Metal pressure springs 403 are attached to the back surface of the upper cabinet 3. The pressure springs 403 have leading end portions positioned in front of the detection switches 401 on the sub board 17.

As shown in FIG. 7A, when the lamp covers 7 are closed, the leading end portions of the pressure springs 403 are pressed by the projecting portions 7b of the levers 7a and are deformed toward the detection switches 401, thereby pressing the button portions 402 of the detection switches 401. Accordingly, the detection switches 401 are closed to input signals indicating closure of the lamp covers 7 into the control part on the control board 16.

Meanwhile, as shown in FIG. 7B, when one of the lamp covers 7 is opened, the projecting portion 7b of the lever 7a is disengaged from the leading end portion of the pressure spring 403 to thereby separate the pressure spring 403 from the button portion 402 of the detection switch 401. Accordingly, the detection switch 401 is opened to input a signal indicating opening of the lamp cover 7 into the control part.

### Configuration of a Control System of the Projector

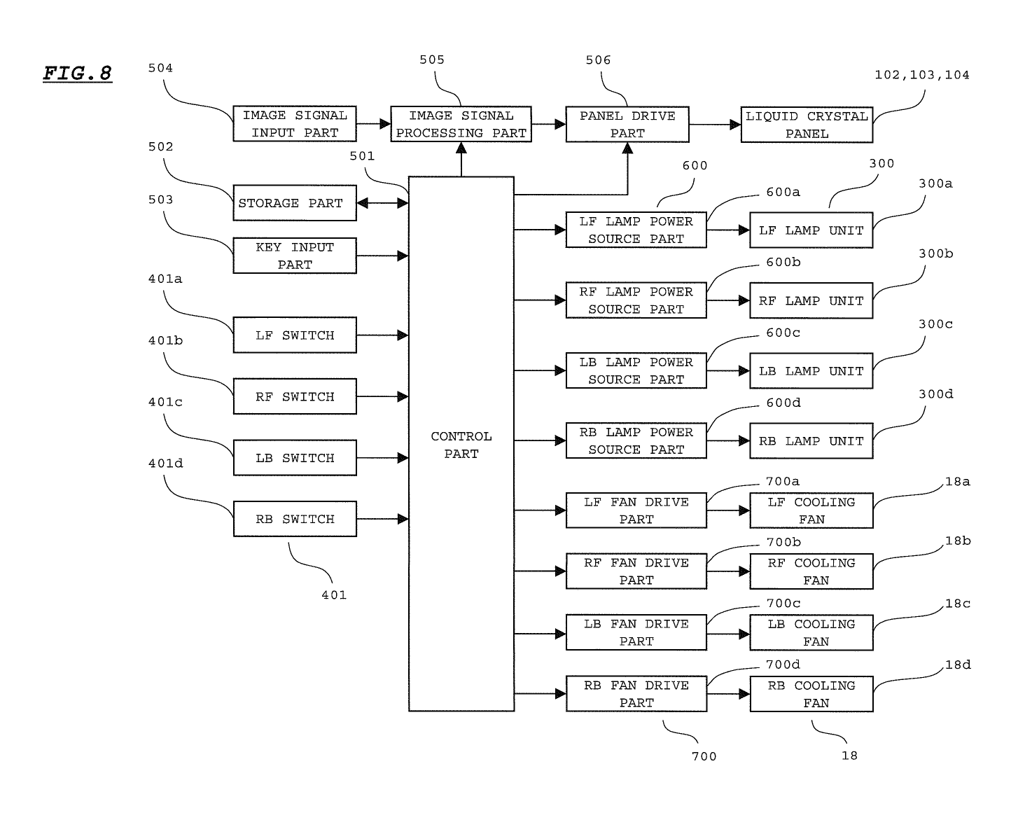

FIG. 8 is a block diagram showing a configuration of a control system of the projector.

The projector includes on the control board 16, a control part 501, a memory part 502, a key input part 503, an image signal input part 504, an image signal processing part 505, and a panel drive part 506. In addition, the projector includes four lamp power source parts 600 corresponding to the lamp units 300. As described above, the lamp power source parts 600 are separated and disposed into a first lamp power source unit 13 and a second lamp power source unit 14.

Further, the projector includes four cooling fans 18 and four fan drive parts 700 corresponding to the lamp units 300. The cooling fans 18 are attached to bottom portions of the lamp attachment units 200 so as to be located under the corresponding lamp units 300. The cooling fans 18 blow cooling air to the lamp units 300 positioned above.

In the following description, if the lamp units 300 are individually specified, the left front lamp unit 300 shown in FIG. 5 is designated as LF lamp unit 300a, for the sake of convenience. Similarly, the right front, left rear, and right rear lamp units 300 are designated as RF lamp unit 300b, LB lamp unit 300c, and RB lamp unit 300d, respectively. In addition, the detection switches 401 corresponding to the LF lamp unit 300a, RF lamp unit 300b, LB lamp unit 300c, and RB lamp unit 300d, are designated as LF switch 401a, RF switch 401b, LB switch 401c, and RB switch 401d, respectively. Further, the lamp power source parts 600 corresponding to the LF lamp unit 300a, RF lamp unit 300b, LB lamp unit 300c, and RB lamp unit 300d, are designated as LF lamp power source part 600a, RF lamp power source part 600b, LB lamp power source part 600c, and RB lamp power source part 600d, respectively. In addition, the cooling fans 18 corresponding to the LF lamp unit 300a, RF lamp unit 300b, LB lamp unit 300c, and RB lamp unit 300d, are designated as LF cooling fan 18a, RF cooling fan 18b, LB cooling fan 18c, and RB cooling fan 18d, respectively. Further, the fan drive parts 700 corresponding to the LF cooling fan 18a, RF cooling fan 18b, LB cooling fan 18c, and RB cooling fan 18d, are designated as LF fan drive part 700a, RF fan drive part 700b, LB fan drive part 700c, and RB fan drive part 700d, respectively. FIG. 8 shows designations and reference numerals for specifying individually the lamp units 300, detection switches 401, lamp power source parts 600, cooling fans 18, and fan drive parts 700.

The key input part 503 outputs an input signal in accordance with operation of each key on an operation part (not shown) to the control part 501.

The image signal input part 504 receives input of image signals from AV terminals of the input/output terminal part 8. The image signal input part 504 subjects the input image signals to a process such as A/D conversion or the like as necessary, and outputs the processed signals to the image signal processing part 505.

The image signal processing part 505 converts the image signals input from the image signal input part 504 into RGB image signals displayable on the liquid crystal panels 102, 103, and 104, and outputs the same to the panel drive part 506.

The panel drive part 506 drives the liquid crystal panels 102, 103, and 104, in accordance with the input image signals and control signals from the control part 501.

The lamp power source parts 600 (LF lamp power source part 600a, RF lamp power source part 600b, LB lamp power source part 600c, and RB lamp power source part 600d) include relays, power factor improvement circuits, lamp ballasts, and the like. The lamp power source parts 600 generate voltage signals for driving the lamp units 300 from alternating voltage signals supplied from a commercial power source, in accordance with control signals from the control part 501, and drive the lamp units 300 (LF lamp unit 300a, RF lamp unit 300b, LB lamp unit 300c, and RB lamp unit 300d) by the generated voltage signals.

The fan drive parts 700 (LF fan drive part 700a, RF fan drive part 700b, LB fan drive part 700c, and RB fan drive part 700d) drive cooling fans 18 (LF cooling fan 18a, RF cooling fan 18b, LB cooling fan 18c, and RB cooling fan 18d) in accordance with control signals from the control part 501.

The memory part 502 is formed by a RAM, a ROM, and the like. The memory part 502 stores a control program for imparting control functions to the control part 501. The control part 501 includes a CPU to control components in accordance with the control program.

In this embodiment, if any of the lamp units 300 enters into the off state due to the end of its life or failure even though electric power is supplied from the lamp power source part 600, the lamp power source part 600 inputs to the control part 501 a signal indicative of the off state of the lamp unit 300. In the case where the lamp unit 300 enters into the off state during operation of the projector, the control part 501 stops passage of electric current to the lamp unit 300 but maintains passage of electric current to the other lamp units 300. This allows the projector to continue operation. The projector provides a predetermined notification to prompt a user to replace the lamp. If having a new lamp unit 300 at hand, the user replaces the off-state lamp unit 300 with the new lamp unit 300 during operation of the projector.

The control part 501 executes a lamp control process for allowing the user to conduct smooth lamp replacement while continuing operation of the projector.

### Lamp Control Process

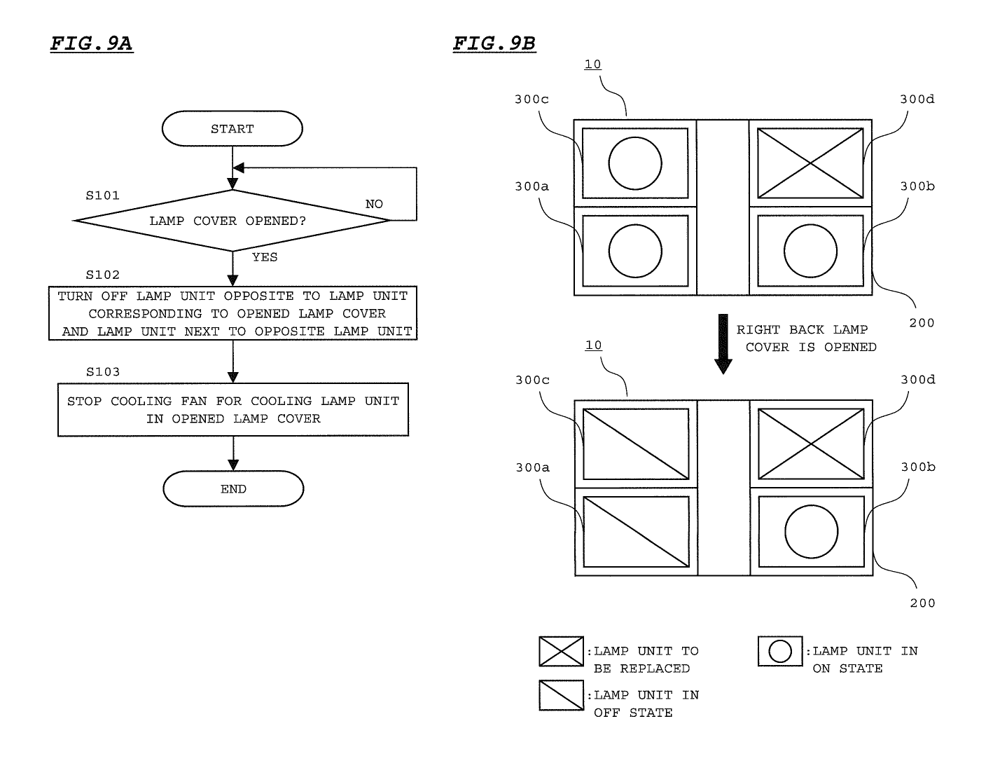

FIGS. 9A and 9B are diagrams for describing a lamp control process at lamp replacement during operation of the projector. FIG. 9A is a diagram showing a procedure of the lamp control process, and FIG. 9B is a diagram showing one example of state transition of the lamp units 300 at execution of the lamp control process. FIG. 9B depicts the light source device 10 schematically.

Referring to FIG. 9A, the control part 501 detects opening/closing of the detection switches 401 during operation of the projector, thereby to monitor whether any of the lamp covers 7 is opened (S101). At that time, if one of the lamp units 300 is in the off state, the control part 501 lets the three remaining lamp units 300 stay on. In addition, the control part 501 operates all the four cooling fans 18 so that the off-state lamp unit 300 can also be cooled continuously.

For lamp replacement, the user opens the lamp cover 7 corresponding to the lamp unit 300 to be replaced. At that time, light emitted from the other lamp units 300 and not reflected by the mirror members 220, that is, leakage light enters the lamp storage part 212 in which the lamp unit 300 to be replaced is stored. In particular, the lamp unit 300 opposite to the lamp unit 300 to be replaced and the lamp unit 300 next to the opposite lamp unit 300, emit light toward the lamp unit 300 to be replaced. Accordingly, the leakage light from these lamp units 300 is likely to enter the lamp storage part 212 in which the lamp unit 300 to be replaced is stored. Therefore, when the lamp cover 7 is opened, light from the lamp opening 3a is prone to be released.

If determining that one of the lamp covers 7 is opened (S101: YES), the control part 501 turns off the lamp unit 300 opposite to the lamp unit 300 corresponding to the opened lamp cover 7 and the lamp unit 300 next to the opposite lamp unit 300 (S102). Accordingly, only the lamp unit 300 next to the lamp unit 300 corresponding to the opened lamp cover 7, stays on.

As shown in FIG. 9B, for example, if the right rear RB lamp unit 300d is in the off state, when the right rear lamp cover 7 is opened, the left rear LB lamp unit 300c and the left front LF lamp unit 300a are turned off, and only the right front RF lamp unit 300b stays on.

As in the foregoing, when any of the lamp covers 7 is opened, two lamp units 300 from which leakage light is likely to travel toward the lamp unit 300 corresponding to the opened lamp cover 7, are turned off, whereby it is possible to suppress significantly release of light from the opened lamp opening 3a.

The control part 501 further stops the cooling fan 18 for cooling the lamp unit 300 corresponding to the opened lamp cover 7 (S103). In the example of FIG. 9B, the RB cooling fan 18d for cooling the RB lamp unit 300d is stopped. This suppresses outflow of cooling air from the opened lamp opening 3a.

Accordingly, during replacement of the lamp unit 300, the operation of the projector, that is, projection of images, is continued only by light emitted from the lamp unit 300 next to the lamp unit 300 being replaced.

When the new lamp unit 300 is attached in the lamp storage part 212 and the lamp cover 7 is closed, the control part 501 then turns on the four lamp units 300 and operates the four cooling fans 18.

### Advantages of this Embodiment

As in the foregoing, according to this embodiment, the lamp units 300 except for the lamp unit 300 corresponding to the opened lamp cover 7 are controlled such that light emitted from the lamp units 300 becomes weak, thereby suppressing release of light from the opened lamp opening 3a. Therefore, the user can replace the lamp unit 300 smoothly without distraction of the released light.

Particularly in this embodiment, two lamp units 300 from which light is likely to travel toward the lamp unit 300 corresponding to the opened lamp cover 7, are turned off. This suppresses significantly release of light from the opened lamp opening 3a.

In addition, according to this embodiment, it is possible to, when the lamp cover 7 is opened, suppress outflow of cooling air from the opened lamp opening 3a. This prevents that the user receives a blow of cooling air and has a feeling of discomfort.

### Modification Example 1

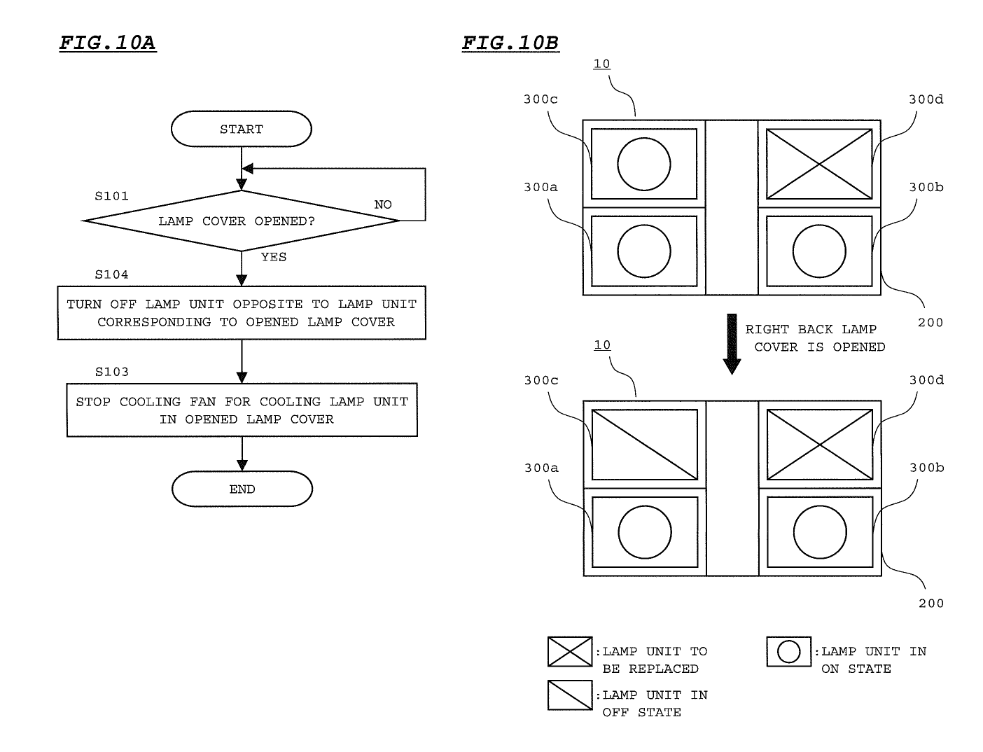

FIGS. 10A and 10B are diagrams for describing a projector in a modification example 1. FIG. 10A is a diagram showing a procedure of a lamp control process, and FIG. 10B is a diagram showing one example of state transition of the lamp units 300 at execution of the lamp control process.

In this modification example, if determining that one of the lamp covers 7 is opened (101: YES), the control part 501 turns off only the lamp unit 300 opposite to the lamp unit 300 corresponding to the opened lamp cover 7 (S104). As shown in FIG. 10B, for example, when the lamp cover 7 corresponding to the right rear RB lamp unit 300d is opened, the left rear LB lamp unit 300c is turned off.

Leakage light from an opposite lamp unit 300 is most likely to enter the lamp storage part 212. Accordingly, as in this modification example, when the opposite lamp unit 300 is turned off, it is possible to suppress effectively release of light from the opened lamp opening 3a, although the released light is slightly larger than that in the foregoing embodiment, and maximize intensity of light emitted from the light source device 10.

### Modification Example 2

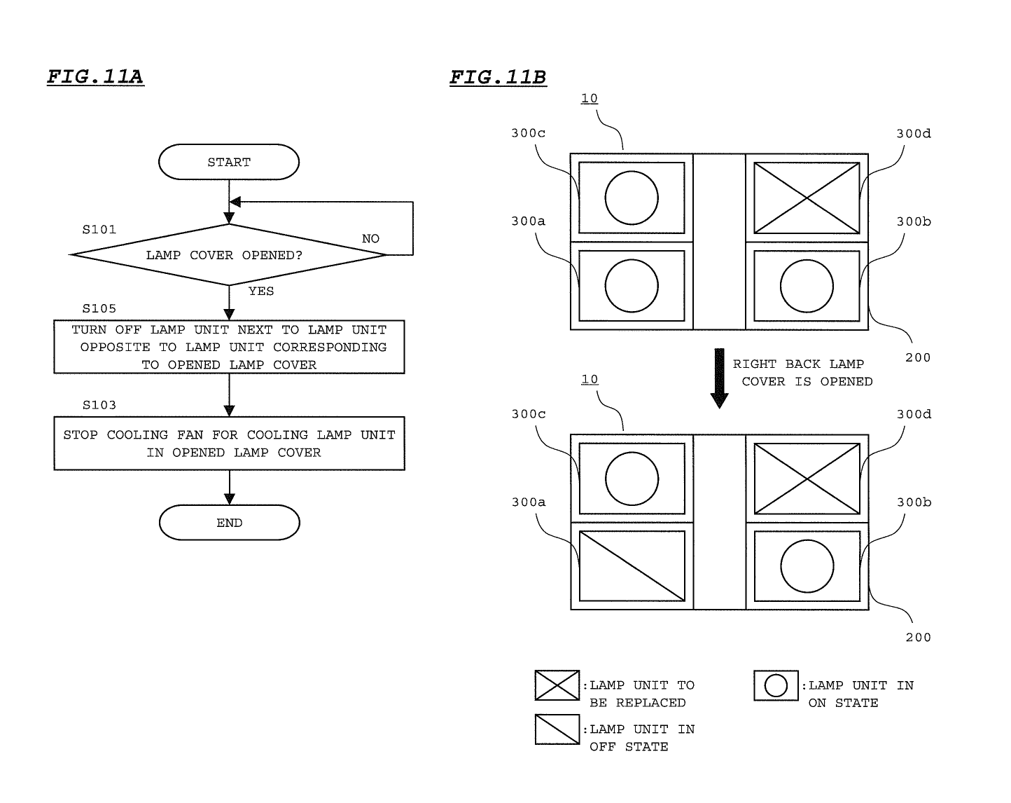

FIGS. 11A and 11B are diagrams for describing a projector in a modification example 2. FIG. 11A is a diagram showing a procedure of a lamp control process, and FIG. 11B is a diagram showing one example of state transition of the lamp units 300 at execution of the lamp control process.

In this modification example, if determining that one of the lamp covers 7 is opened (S101: YES), the control part 501 turns off only the lamp unit 300 next to the lamp unit 300 opposite to the lamp unit 300 corresponding to the opened lamp cover 7 (S105). As shown in FIG. 11B, for example, when the lamp cover 7 corresponding to the right rear RB lamp unit 300d is opened, the left front LF lamp unit 300a is turned off.

As described above, the optical system 11 includes the dichroic mirror and the liquid crystal panels 102, 103, and 104. Light from the left-side LF lamp unit 300a and LB lamp unit 300c, and light from the right-side RF lamp unit 300b and RB lamp unit 300d, are different in angle of incident on the dichroic mirror. This produces a difference between color components of light from the lamp unit 300a and 300c passing through the dichroic mirror and color components of light from the lamp units 300b and 300d passing through the dichroic mirror. In addition, light from one lamp unit 300 enters the liquid crystal panels 102, 103, and 104 at varied angles. This causes color unevenness in projected images if only one lamp unit 300 is turned on. Meanwhile, when the four lamp units 300 are turned on, characteristics of light from the lamp units 300 compensate for each other, thereby cancelling out color unevenness. In addition, the LF lamp unit 300a and the RB lamp unit 300d in diagonal positions seen from above, bring about mirror-reversed color unevenness states in images and thus have characteristics of cancelling out color unevenness each other. Similarly, the RF lamp unit 300b and the LB lamp unit 300c have characteristics of cancelling out color unevenness each other. This matter is described in detail in JP 3594543.

In this modification example, the lamp unit 300 next to the lamp unit 300 opposite to the lamp unit 300 corresponding to the opened lamp cover 7, that is, the lamp unit 300 located in a position diagonal with the lamp unit 300 corresponding to the opened lamp cover 7 and having characteristics of cancelling out color unevenness with the corresponding lamp unit 300, is turned off. Then, the two other lamp units 300 having the characteristics of cancelling out color unevenness each other, stay on.

Accordingly, in the configuration of this modification example, it is possible to suppress occurrence of color unevenness in projected images while reducing release of light from the opened lamp opening 3a, although the release of the light is slightly larger than that in the foregoing embodiment.

The configurations of modification examples 1 and 2 are in particular useful in projectors configured to have the mirror placement parts 211 with high shielding property so that smaller amount of light leaks from the other lamp units 300 to the lamp storage part 212, for example.

### Modification Example 3

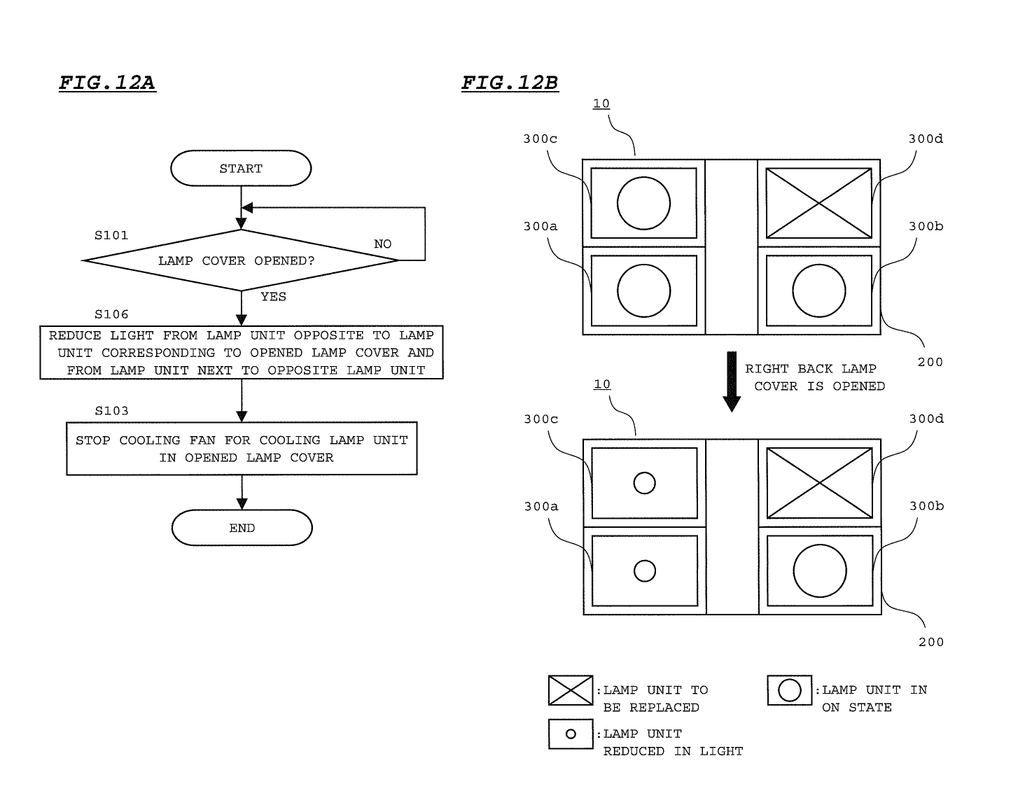

FIGS. 12A and 12B are diagrams for describing a projector in a modification example 3. FIG. 12A is a diagram showing a procedure of a lamp control process, and FIG. 12B is a diagram showing one example of state transition of the lamp units 300 at execution of the lamp control process.

In this modification example, if determining that one of the lamp covers 7 is opened (S101: YES), the control part 501 reduces light emitted from the lamp unit 300 opposite to the lamp unit 300 corresponding to the opened lamp cover 7 and the lamp unit 300 next to the opposite lamp unit 300 (S106). That is, the control part 501 lowers output of the two lamp units 300. As shown in FIG. 12B, for example, when the lamp cover 7 corresponding to the right rear RB lamp unit 300d is opened, the left rear LB lamp unit 300c and the left front LF lamp unit 300a are reduced in light emission.

According to the configuration of this modification example, it is possible to enhance intensity of light emitted from the light source device 10, although release of light from the opened lamp opening 3a becomes larger than that in the foregoing embodiment.

The two lamp units 300 reduced in light may be equal or different in degree of light reduction (light intensity after light reduction). If the degree of light reduction is to be different, it is desired to make higher the degree of light reduction at the lamp unit 300 opposite to the lamp unit 300 from which a larger amount of leakage light travels toward the lamp unit 300 corresponding to the opened lamp cover 7.

### Modification Example 4

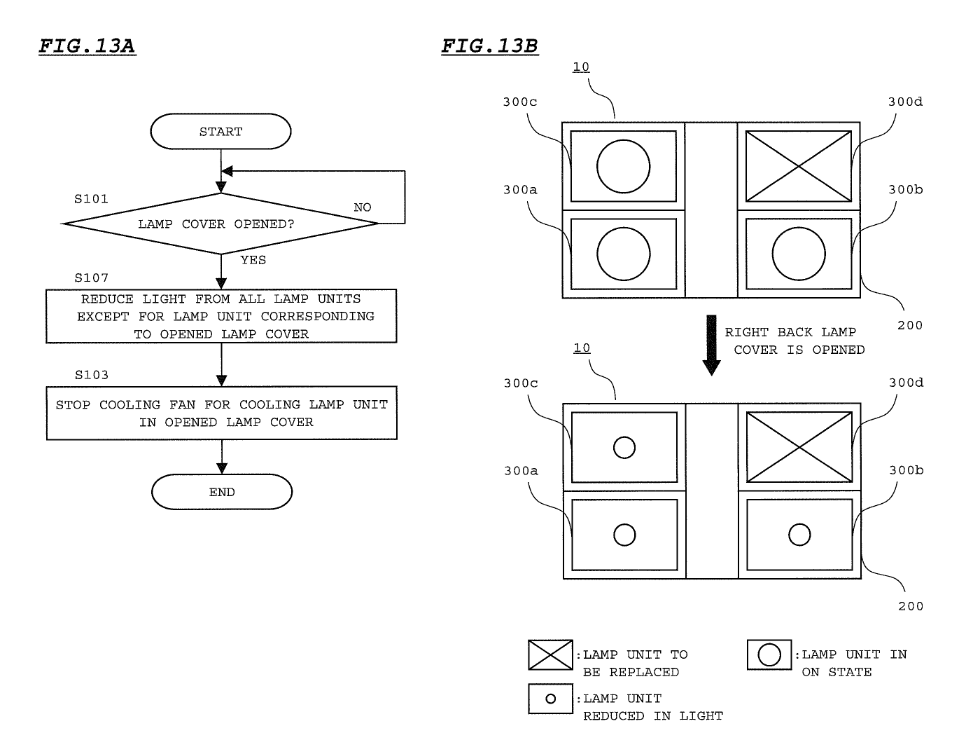

FIGS. 13A and 13B are diagrams for describing a projector in a modification example 4. FIG. 13A is a diagram showing a procedure for a lamp control process, and FIG. 13B is a diagram showing one example of state transition of the lamp units 300 at execution of the lamp control process.

In this modification example, if determining that one of the lamp covers 7 is opened (S101: YES), the control part 501 reduces light emitted from all the lamp units 300 except for the lamp unit 300 corresponding to the opened lamp cover 7 (S107). As shown in FIG. 13B, for example, when the lamp cover 7 corresponding to the right rear RB lamp unit 300d is opened, the control part 501 reduces light emitted from the left rear LB lamp unit 300c, the left front LF lamp unit 300a, and the right front RF lamp unit 300b.

According to the configuration of this modification example, it is possible to reduce release of light from the opened lamp opening 3a, although the intensity of light emitted from the light source device 10 is lower than that in the configuration of the modification example 3. In addition, the configuration of this modification example improves the characteristics of cancelling out color unevenness between the lamp unit 300 opposite to the lamp unit 300 corresponding to the opened lamp cover 7 and the lamp unit 300 next to the lamp unit 300 corresponding to the opened lamp cover 7. Accordingly, it is possible to suppress occurrence of color unevenness in projected images, as compared with the configuration of the modification example 3.

In addition, the two lamp units 300 having the characteristics of cancelling out color unevenness each other are equalized in degree of light reduction (light intensity after light reduction). The two lamp units 300 and another lamp unit 300 may be identical or different in degree of light reduction.

### Others

Although an embodiment of the present invention is as described above, the present invention is not limited to this embodiment. In addition, the embodiment of the present invention can further be modified in various manners besides the foregoing ones.

The upper cabinet 3 may be provided with a mechanism part which, when one of the lamp covers 7 is opened, disables the other lamp covers 7 to be opened, so that, if two or more lamp units 300 go out, the lamp units 300 can be replaced one by one.

In addition, in the foregoing embodiment, the lamp unit 300 opposite to the lamp unit 300 corresponding to the opened lamp cover 7 and the lamp unit 300 next to the opposite lamp unit 300 are turned off. Alternatively, the lamp unit 300 next to the opposite lamp unit 300 may not be turned off but reduced in light emission.

Further, in the foregoing embodiment, when one of the lamp covers 7 is opened, the cooling fan 18 corresponding to the opened lamp cover 7 is stopped. Alternatively, the cooling fan 18 may not be necessarily stopped.

Moreover, in the foregoing embodiment, light emitted from the lamp units 300 is reflected by the mirror members 220 (plane mirrors 222) for combination. Alternatively, the light combining part may use prisms, not mirrors as described above.

In addition, in the foregoing embodiment, the light source device 10 is formed by the lamp units 300 using lamp light sources. Alternatively, the light source device 10 may be formed by light source units using LED light sources or laser light sources.

Further, the projector in the foregoing embodiment is a four-lamp type projector. Alternatively, the projector may be a multi-lamp projector other than the four-lamp type.

Besides, the embodiment of the invention may be changed or modified as appropriate in various manners, within the scope of technical ideas in the claims.

What is claimed is:

1. A projection display device, comprising:
a light source device which has a plurality of light source parts, and combines light from the light source parts and outputs the same;
a light modulating part which modulates light output from the light source device;
a main body cabinet in which the light source device and the light modulating part are disposed;
a plurality of opening parts which are provided in the main body cabinet and through which the light source parts are individually put into or taken out;
a plurality of covers which cover the corresponding opening parts; and
a light source control part which controls the light source parts, wherein
when any of the covers is opened during operation, the light source control part controls the light source parts except for the light source part corresponding to the opened cover, in such a manner as to reduce intensity of light emitted from the light source parts.

2. The projection display device according to claim 1, wherein
the light source device includes a first light source part and a second light source part opposite to the first light source part, and
when the cover corresponding to the first light source part is opened, the light source control part turns off the second light source part or reduces light emitted from the same.

3. The projection display device according to claim 2, wherein
the light source device includes a third light source part adjacent to the first light source part and a fourth light source part opposite to the third light source part, and
when the cover corresponding to the first light source part is opened, the light source control part turns off the second light source part and the fourth light source part or reduces light emitted from the same.

4. The projection display device according to claim 1, wherein
the light source device includes a first light source part and a second light source part having the characteristic of cancelling out color unevenness each other, and
when the cover corresponding to the first light source part is opened, the light source control part turns off the second light source part or reduces light emitted from the same.

5. The projection display device according to claim 1, wherein
the light source control part reduces light emitted from all the light source parts except for a light source part corresponding to the opened cover.

6. The projection display device according to claim 1, further comprising:
a plurality of cooling fans which cool the corresponding light source parts, and
a fan control part which controls the cooling fans, wherein
the fan control part stops a cooling fan for cooling a light source part corresponding to the opened cover.
